(19) United States
(12) Patent Application Publication
(10) Pub. No.: US 2003/0112248 A1
(43) Pub. Date: Jun. 19, 2003

(54) VGA quad device and apparatuses including same

(75) Inventor: Viatcheslav Pronkine, Edgewater, NJ (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/024,780

(22) Filed: Dec. 19, 2001

(51) Int. Cl. G09G 5/39; G09G 5/36

(52) U.S. Cl. 345/545; 345/531

(57) ABSTRACT

A frame buffer (100, 300) receives N asynchronous digital video signals and generates a data stream corresponding to a single video signal representing all of the N asynchronous video signals responsive to read and write memory addresses generated by a frame buffer controller (200, 400), where N is an integer greater than or equal to 2. If desired, N can be a positive integer equal to or greater than 4. Preferably, the frame buffer includes N dual ported memory devices (110, 120, 130, 140), each or which can be written to and read from simultaneously and independently. A VGA quad device and apparatuses incorporating same are also described.

### BACKGROUND OF THE INVENTION

The present invention relates generally to a VGA quad device that displays a single video image generated by multiple video image sources. More specifically, the present invention relates to a VGA quad device that displays a single video image generated by multiple video image sources and stored in an integrated frame buffer. Advantageously, improved devices such as an improved keyboard, video, mouse (KVM) switch including the novel VGA quad device are also disclosed.

A VGA quad device is extremely useful in situations where the ability to monitor multiple high-resolution video sources is required or desired. This is particularly true in situations where the use of multiple monitors is prohibited due to space or cost considerations.

Before discussing the background in which the present invention was made, it would be useful to establish certain terminology that shall be employed in the discussion of both the background and the preferred embodiments according to the present invention. In particular, the following terms will be employed throughout:

VGA generally refers to any high-resolution analog or digital video signal. Thus, VGA as used herein is not limited to the defacto industry standard analog display producing a 640×480 pixel (pel) image at 60, 70, or 72 Hertz (Hz) but, rather, includes VGA, SVGA, and XGA, to name but a few.

Quad in the context of the present invention simply means multiple. The term was retained from prior art security system components that, as will be discussed immediately below, display four video images simultaneously.

One desiring to display the outputs of multiple desktop or laptop computers simultaneously has a limited number of choices. First, the user may set up a separate monitor for each computer being monitored. It will be appreciated that this would be expensive in turns of monitor costs and wasteful in terms of space and power consumed.

Alternatively, the user could cycle through the outputs of the various computers, displaying only one of the, for example, four video images being generated at any one time. Several KVM switches possess this capability. It will be appreciated that even if the cycle rate is relatively short, e.g., 2 seconds, the user will be unable to monitor the output of any given computer for 6 of every 8 seconds. This may be totally unacceptable in various applications.

Devices known generically as “video quads” or “quad splitters” receive inputs from multiple video sources, e.g., video cameras and provide a single composite feed to a connected monitor. These conventional video quads are not suitable for high-resolution component video signals.

There are several other conventional techniques and components for generating a “quad” display. For example, four port video capture cards are commercially available which permit the user to generate an image file for each of four video inputs; these four images may then be observed sequentially or simultaneously using a browser to display an HTML page linked to the four images generated by the video capture card.

Alternatively, multiple input images may be combined into a single output, as discussed in U.S. Pat. No. 5,872,565 to Greaves et al., which is entitled “real-time video processing system,” and which is incorporated herein, in its entirety, by reference. In the system disclosed by Greaves et al. several video switchers are employed, at least one of which is coupled to a video bus to thereby receive upstream-processed video signals from the upstream video processing cards and combine the upstream-processed video signals in accordance with control information received over a main control bus to provide a composite video signal. It will be appreciated that the input video signals to the system disclosed by Greaves et al. must be synchronized to a uniform time base in order to switch between the various input video signals.

A video switcher for switching between asynchronous video sources is disclosed in U.S. Pat. No. 6,172,710 to Yoshida, which patent is entitled frame converter for asynchronous video signals, and which patent is also incorporated herein by reference in its entirety. In U.S. Pat. No. 6,172,710, multiple video frames from N video sources are multiplexed into N/2 frame buffers. It will be appreciated that this system, while avoiding expensive synchronized video cameras or time base conversion circuitry, the problem of gaps within the output images still exist.

What is needed is a VGA quad device that permits display of multiple high-resolution video signals without “data gaps.” It would be desirable in the VGA quad device could receive a multiple asynchronous high-resolution video signals. It would also be desirable if the VGA quad device were software and/or operating system independent. What is also needed is an improved apparatus, a KVM switch for example, which includes the VGA quad device.

### SUMMARY OF THE INVENTION

Based on the above and foregoing, it can be appreciated that there presently exists a need in the art for a VGA quad device that overcomes the above-described deficiencies. The present invention was motivated by a desire to overcome the drawbacks and shortcomings of the presently available technology, and thereby fulfill this need in the art.

According to one aspect, the present invention provides a frame buffer receiving N asynchronous digital video signals and generating a data stream corresponding to a single video signal representing all of the N asynchronous video signals responsive to read and write memory addresses generated by a frame buffer controller, where N is an integer greater than or equal to 2. If desired, N can be a positive integer equal to or greater than 4. Preferably, the frame buffer includes N dual ported memory devices, each or which can be written to and read from simultaneously and independently.

According to another aspect, the present invention provides a VGA quad device receiving N asynchronous digital video signals and generating a single video signal representing all of the N asynchronous video signals. Preferably, the VGA quad device includes a frame buffer which stores data corresponding to the single video signal, and a controller generating write addresses permitting digital data corresponding to the N asynchronous digital video signals to be written into the frame buffer and read addresses permitting the data stored in the frame buffer to be read out as a single data block, where N is an integer equal to or greater that 2. If desired, the frame buffer includes N dual ported memory devices, each of which can be written to and read from simultaneously. In an exemplary case, the N asynchronous video signals include N analog video signals; in that case, the VGA quad device also includes N analog-to-digital converters receiving the N analog video signals and generating the N asynchronous video signals, respectively. In an alternative case, the VGA quad device includes a digital-to-analog converter receiving the data stored in the frame buffer and generating the single video signal representing all of the N asynchronous video signals.

According to a further aspect, the present invention provides a VGA quad device receiving N asynchronous digital video signals and generating a single video signal representing all of the N asynchronous video signals, which includes frame buffer circuitry for storing data corresponding to the single video signal, converter circuitry receiving the data corresponding to the single video signal for converting the data into the single video signal, and controller circuitry for generating write addresses permitting digital data corresponding to the N asynchronous digital video signals to be written into the frame buffer and for generating read addresses permitting the data stored in the frame buffer to be output to the converter circuitry, where N is an integer equal to or greater that 2. In an exemplary case, the frame buffer circuitry includes N dual ported memory devices, which can be written to and read from simultaneously. If another exemplary case, the N asynchronous video signals include N analog video signals; in that case, the VGA quad device further includes second converter circuitry for receiving the N analog video signals and for generating the N asynchronous video signals, respectively.

According to a still further aspect, the present invention provides a VGA quad device receiving N asynchronous digital video signals and generating a single video signal representing all of the N asynchronous video signals, including N video buffers which receive N asynchronous digital video signals and which store N data groups corresponding to the N asynchronous video signals, a frame buffer which stores the N data groups as data corresponding to the single video signal and outputs the data for display, a controller generating read/write addresses applied to the N video buffers and the frame buffer to thereby permit digital data corresponding to the N asynchronous digital video signals to be transferred from the N video buffers into the frame buffer and read addresses permitting the data stored in the frame buffer to be read out as a single data block, where N is an integer equal to or greater that 2. If desired, the N video buffers can include N respective dual ported memory devices, which can be written to and read from simultaneously. Preferably, the N asynchronous video signals include N analog video signals; in that case, the VGA quad device further includes N analog-to-digital converters receiving the N analog video signals and generating the N asynchronous video signals, respectively. In an alternative case, the VGA quad device includes a digital-to-analog converter receiving the data stored in the frame buffer and generating the single video signal representing all of the N asynchronous video signals.

According to yet another aspect, the present invention provides a KVM switch having a first operating mode permitting a selected one of N asynchronous video signals to be output for display and a second operating mode permitting a single video signal corresponding to the N asynchronous video signals to be output for display. The KVM switch includes a first selector switch receiving the N asynchronous video signals and outputting the selected one of the N asynchronous video signals as a selected video signal, a frame buffer which stores data corresponding to the single video signal, an analog-to-digital converter which receives the data corresponding to the single video signal and converts the data into the single video signal, a second selector switch which receives the output of the first video switch and the converter and outputs one of the selected video signal and the single video signal, and a controller which generates write addresses permitting digital data corresponding to the N asynchronous digital video signals to be written into the frame buffer and which generates read addresses permitting the data stored in the frame buffer to be output to the converter, where N is an integer equal to or greater that 2. If desired, the second switch is controlled by the controller.

### BRIEF DESCRIPTION OF THE DRAWINGS

These and various other features and aspects of the present invention will be readily understood with reference to the following detailed description taken in conjunction with the accompanying drawings, in which like or similar numbers are used throughout, and in which:

FIG. 1 is a high-level block diagram of a VGA quad device according to a first preferred embodiment according to the present invention;

FIG. 2 is a high-level block diagram of a VGA quad device according to a second preferred embodiment according to the present invention;

FIG. 3 is a high-level bock diagram of a KVM switch incorporating the VGA quad device illustrated in either FIG. 1 or FIG. 2.

### DETAILED DESCRIPTION OF THE PREFERRED EMBODIMENTS

As discussed above, a VGA quad device according to the present invention is extremely useful in situations where the ability to monitor multiple high-resolution video sources is required or desired. This is particularly true in situations where the use of multiple monitors is prohibited due to space or cost considerations.

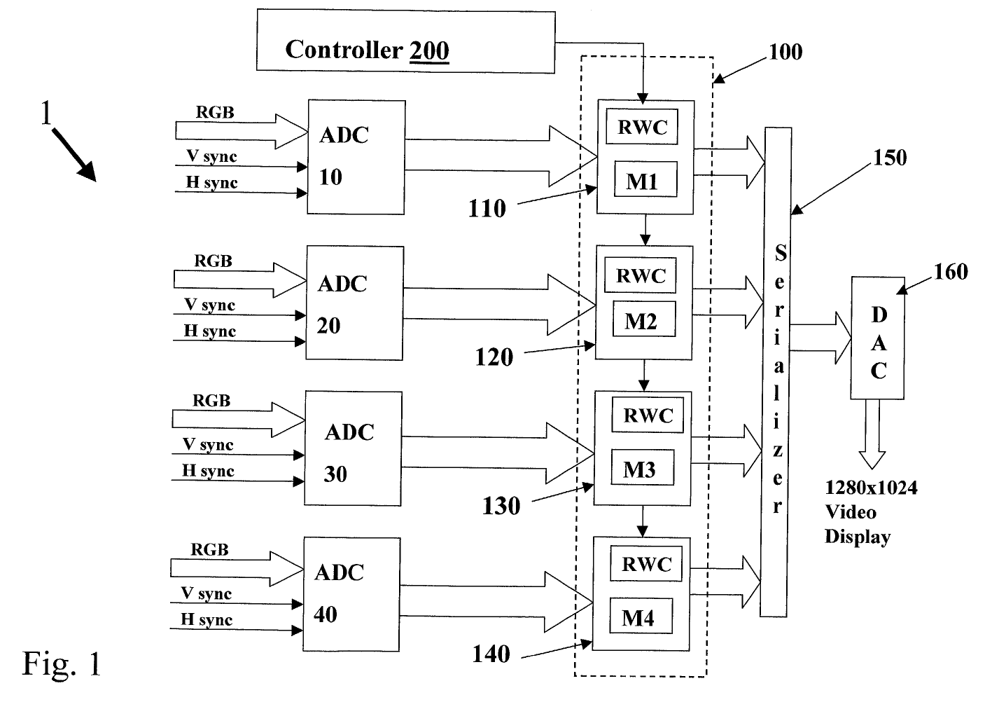

FIG. 1 is a high-level block diagram of a VGA quad device 1 according to a first preferred embodiment according to the present invention, which advantageously includes a frame buffer 100 controlled by a frame buffer controller 200. Preferably, each of multiple video sources (not shown) are applied to a respective video input interface, which in the exemplary case illustrated in FIG. 1 are depicted as analog-to-digital converters (ADCs) 10, 20, 30, and 40. It will be noted that each of the ADCs 10-40 advantageously receive both a video signal, e.g., an analog RGB video signal, and synchronization signals H sync and V sync. It will be appreciated that the ADCs 10-40 advantageously can be video digitizers or video encoders, which devices are well known to one of ordinary skill in the art. It will also be appreciated that the ADCs 10-40 can generate any desired number of bits, although eight (8) bits are sufficient to display full range of colors which minimizing memory size (discussed below).

It should be noted at this point that the present invention is not limited to analog video signal applications. The video signals ultimately applied to the frame buffer 100 advantageously can be digital video signals. In that case, the ADCs can be replaced by direct video input (DV-IN) elements (not shown), which advantageously may include Digital Video Interface (DVI) components, dedicated buses, and the like.

Still referring to FIG. 1, the frame buffer 100, in an exemplary case, includes a plurality of memory devices, e.g., memories 110, 120, 130, and 140. Preferably, all of these memories 110-140 are dual ported memories such as video random access memory (VRAMs), which permits independent writes to and reads from each memory via independent respective input and output ports. Thus, each of the memories 110-140 of frame buffer 100 is depicted as including a memory cell arrays, e.g., array M1, and a read-write controller RWC.

It will be appreciated that the frame buffer 100 illustrated in FIG. 1 advantageously includes four memory cell arrays M1-M4, which can be virtually arranged during readout to form a quad display. The frame buffer 100 preferably corresponds to a 1280×960 pixel display, i.e., it accommodates enough data for four full 640×480 VGA screens. It will be appreciated that the frame buffer 100 advantageously can be 1280×1024, with the extra lines (1024−960=64 lines) being employed to pad the top and bottom of the larger display array, with such padding area optionally employed for displaying statistical or environmental information including, but not limited to, current date and time. In any event, the memory cell arrays M1-M4 can be read out as follows:

| | |
|---|---|
| M1 | M2 |
| M3 | M4 |

Thus, in an exemplary case, data representing 640 pixels can be read out of memory 110, then out of memory 120, thereby providing data for line 1 of a 1280×1024 XGA display image. This readout pattern can be repeated until 480 lines have been read out of memories 110 and 120. Then, data corresponding to the next 480 lines can be read out of the memories 130 and 140.

It should be mentioned at this point that the output of the frame buffer 100 is applied to a digital-to-analog converter (DAC) via a serializer 150. The function of the serializer 150 is match data rates between the relatively high output rate of the frame buffer 100 and the relatively low data input rate of the DAC 160. It will be appreciated that serializer, optional color converters, e.g., a RAMDAC, or YUV to RGB converter, and rate matching devices, such as first-in/first-out (FIFO) elements and like, are conventional elements included in substantially all video graphics controllers and, thus, video accelerator cards. Further discussion of these devices will not be presented.

It should also be mentioned that the controller 200 generates the write addresses applied to the memories 110-140 of frame buffer 100 to permit the output of the ADCs 10-40 to be written into specific locations in the memories. It will be appreciate that the controller 200 advantageously can generate address signals destined for all of the memories 110-140, which addresses are delayed until the H sync and V sync signals of an associated one of analog video signals indicate that the pixel data output by the ADC matches the generated write address. Delay and logic elements are well known to one of ordinary skill in the art. Thus, given the instant disclosure, it is expected that a myriad of circuit arrangements needed to write data to a selected memory irrespective of the timing of the corresponding analog video signal will suggest themselves to one of ordinary skill in the art. All such circuit arrangements are considered to be within the scope of the present invention.

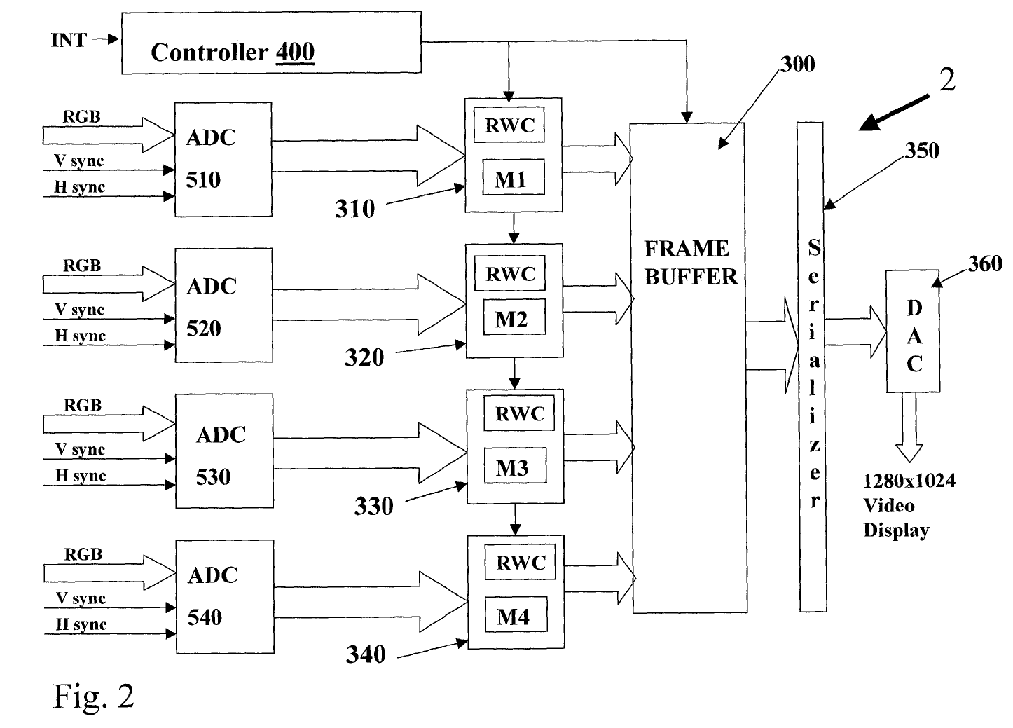

FIG. 2 is a high-level block diagram of a VGA quad device 2 according to a second preferred embodiment according to the present invention, which advantageously includes a frame buffer 300 controlled by a frame buffer controller 400. Preferably, each of multiple video sources (not shown) are applied to a respective video input interface, which in the exemplary case illustrated in FIG. 2 are depicted as analog-to-digital converters (ADCs) 510, 520, 530, and 540. It will be noted that the ADCs 510-540 advantageously receive both a video signal, e.g., an analog RGB video signal, and synchronization signals H sync and V sync. The output of the frame buffer 300 is applied to the monitor via a serializer 350 and a DAC 360.

It will be appreciated that there are several differences between the VGA quad device illustrated in FIG. 1 and the VGA quad device illustrated in FIG. 2. Most notably, the output of the ADCs 510, 520, 530, and 540 are routed to the frame buffer 300 via respective video buffers 310, 320, 330, and 340, which advantageously can be the dual ported memory devices such as those described in connection with frame buffer components 110, 120, 130, and 140. It will also be appreciated that the addition of the video buffers 310, 320, 330, and 340 to the VGA quad device permits additional flexibility for the overall device. For example, the controller 400 advantageously can provide read and write addresses to the frame buffer and the video buffers, which permit the contents of the frame buffer to be re-arranged. This re-arrangement could be simply changing the order of storage and subsequent readout. Alternatively, the arrangement illustrated in FIG. 2 could be employed to store images of arbitrary sizes. Given that the VGA quad device is not limited to the display of four images, a fifth (or fifth, sixth, and seventh) video signal channel(s) advantageously can be added to the VGA quad device. Such a device could display three 640×480 pixel images as well as two (three or four) 320×240 pixel images. It will be appreciated that the 320×240 pixel image size could be generated by either dedicated decimation circuitry or having the controller 400 provide addresses for reading out every other pixel in a row and every other row in a frame. Other arrangements are also possible and all such arrangements are considered to be within the scope of the present invention.

The discussion immediately high lights the fact that the present invention is not limited to display resolutions where the each of the video signals displayed is a fractional form of the original video signal image, where the denominator of the fraction is a positive integer. The present invention, given the functionalities provided by the controllers 200 and 400, is fully capable of “advanced scaling” and include advanced scaling circuitry. Such circuitry permits the apparatuses according to the present invention to display different resolution input signals or to present each of the displayed images in its best quality resolution. Stated another way, the VGA quad device according to the present invention is capable of scaling each of the images stored, for example, in the video buffers 310, 320, 330, and 340, by a different decimal number, rather than an integer number as the contents of the video buffers are being written to the frame buffer 300. It will be appreciated that this is a particularly desirable feature for situations where one of the video signals represent a high resolution image, e.g., an HDTV image, while the other monitored video signal images are derived from 640×480 pixel PC displays.

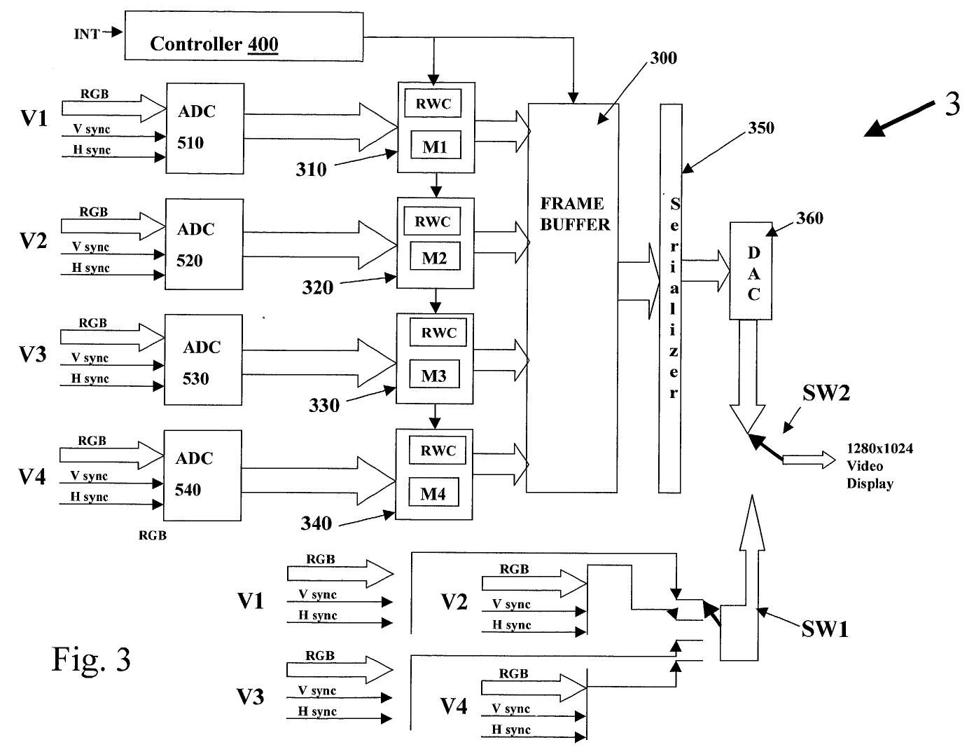

It should be mentioned that the controller 400 advantageously can receive various control signals from other electrical or electronic devices, as indicated by the controller input port labeled INT. The advantage of a control input can best be appreciated from the improved KVM switch 3 according to the present invention illustrated in FIG. 3, wherein a device for controlling four computers using a single keyboard, video and mouse is illustrated.

In FIG. 3, the KVM switch 3 receives four video signals V1 through V4, any one of which can be selected using a switch SW1 included in the KVM switch. In addition, the video signals V1 through V4 are applied to the ADCs 510, 520, 530, and 540, respectively. The video signals V1 through V4 are stored and then output from the frame buffer 300, as discussed with respect to FIG. 2. It should be noted that the VGA quad device illustrated in FIG. 1 advantageously can be substituted for that illustrated in FIG. 2. In any event, one of the outputs of the DAC 360 and the switch SW1 is selected via a switch SW2, which advantageously can be controlled by the controller 400. More specifically, as long as the mouse connected to the KVM switch is stationary, the switch SW2 selects the output of the DAC 360 associated with the VGA quad device. However, when the mouse is moved, an interrupt signal INT is generated and applied to the controller 400, which generates a control signal causing the switch SW2 to shift to the opposite position, which, in turn, permits the one of the video signals V1 through V4 selected by the switch SW1 to be applied to the attached monitor (not shown). It will be appreciated that other devices, e.g., the keyboard, advantageously can generate the interrupt signal mentioned above.

Advantageously, application of the VGA quad device according to the present invention need not be limited to computer systems. The VGA quad device can be integrated into other “consumer” electronic devices such as set top boxes and television monitors. For example, the VGA quad device can be integrated into the display of a multimedia system including, for example, a DVD player, a satellite receiver with picture-in-picture (PIP) capability, a personal video recorder, and a personal computer. Each of these video sources could be monitored and displayed simultaneously. The ability to monitor all active video sources simultaneously would be particularly useful in the modern electronic home, since it would permit parental monitoring a child's viewing choices.

It should be noted that the resolution of the video image generated by the conventional PIP circuitry is too small to permit meaningful monitoring, principally because of the number of decimation stages that the image is subjected to on its way to the display device. However, since the PIP receiver is capable of generating a full resolution image, that image advantageously can be applied to one input of the VGA quad device according to the present invention.

The VGA quad device according to the present invention would also be particularly desirable in high definition television (HDTV) broadcast studios, where multiple reduced images of high definition video sources must be monitored. In that application, the VGA quad device would provide a substantial savings in cost of the monitoring equipment and a comparable savings in space taken up by this monitoring equipment.

Although presently preferred embodiments of the present invention have been described in detail herein, it should be clearly understood that many variations and/or modifications of the basic inventive concepts herein taught, which may appear to those skilled in the pertinent art, will still fall within the spirit and scope of the present invention, as defined in the appended claims.

What is claimed is:

1. A frame buffer receiving N asynchronous digital video signals and generating a data stream corresponding to a single video signal representing all of the N asynchronous video signals responsive to read and write memory addresses generated by a frame buffer controller, where N is an integer greater than or equal to 2.

2. The frame buffer as recited in claim 1, wherein N is a positive integer equal to or greater than 4.

3. The frame buffer as recited in claim 1, wherein the frame buffer includes N dual ported memory devices, each of which can be written to and read from simultaneously and independently.

4. A VGA quad device receiving N asynchronous digital video signals and generating a single video signal representing all of the N asynchronous video signals, comprising:
a frame buffer which stores data corresponding to the single video signal;
a controller generating write addresses permitting digital data corresponding to the N asynchronous digital video signals to be written into the frame buffer and read addresses permitting the data stored in the frame buffer to be read out as a single data block,
where N is an integer equal to or greater that 2.

5. The VGA quad device as recited in claim 4, wherein the frame buffer comprises N dual ported memory devices, each of which can be written to and read from simultaneously.

6. The VGA quad device as recited in claim 4, wherein:
the N asynchronous video signals comprise N analog video signals; and
the VGA quad device further comprises:
N analog-to-digital converters receiving the N analog video signals and generating the N asynchronous video signals, respectively.

7. The VGA quad device as recited in claim 4, further comprising a digital to analog converter receiving the data stored in the frame buffer and generating the single video signal representing all of the N asynchronous video signals.

8. A VGA quad device receiving N asynchronous digital video signals and generating a single video signal representing all of the N asynchronous video signals, comprising:
frame buffer means for storing data corresponding to the single video signal;
converter means receiving the data corresponding to the single video signal for converting the data into the single video signal; and
controller means for generating write addresses permitting digital data corresponding to the N asynchronous digital video signals to be written into the frame buffer and for generating read addresses permitting the data stored in the frame buffer to be output to the converter means,
where N is an integer equal to or greater that 2.

9. The VGA quad device as recited in claim 8, wherein the frame buffer means comprises N dual ported memory devices, which can be written to and read from simultaneously.

10. The VGA quad device as recited in claim 8, wherein:
the N asynchronous video signals comprise N analog video signals; and
the VGA quad device further comprises:
second converter means for receiving the N analog video signals and for generating the N asynchronous video signals, respectively.

11. A VGA quad device receiving N asynchronous digital video signals and generating a single video signal representing all of the N asynchronous video signals, comprising:
N video buffers which receive N asynchronous digital video signals and which store N data groups corresponding to the N asynchronous video signals;
a frame buffer, which stores the N data groups as data corresponding to the single video signal and outputs the data for display;
a controller generating read/write addresses applied to the N video buffers and the frame buffer to thereby permit digital data corresponding to the N asynchronous digital video signals to be transferred from the N video buffers into the frame buffer and read addresses permitting the data stored in the frame buffer to be read out as a single data block,
where N is an integer equal to or greater that 2.

12. The VGA quad device as recited in claim 11, wherein the N video buffers comprise N respective dual ported memory devices, which can be written to and read from simultaneously.

13. The VGA quad device as recited in claim 11, wherein:
the N asynchronous video signals comprise N analog video signals; and
the VGA quad device further comprises:
N analog-to-digital converters receiving the N analog video signals and generating the N asynchronous video signals, respectively.

14. The VGA quad device as recited in claim 11, further comprising a digital-to-analog converter receiving the data stored in the frame buffer and generating the single video signal representing all of the N asynchronous video signals.

15. A KVM switch having a first operating mode permitting a selected one of N asynchronous video signals to be output for display and a second operating mode permitting a single video signal corresponding to the N asynchronous video signals to be output for display, comprising:
a first selector switch receiving the N asynchronous video signals and outputting the selected one of the N asynchronous video signals as a selected video signal;
a frame buffer which stores data corresponding to the single video signal;
an analog-to-digital converter, which receives the data corresponding to the single video signal and converts the data into the single video signal;
a second selector switch which receives the output of the first video switch and the converter and outputs one of the selected video signal and the single video signal; and
a controller which generates write addresses permitting digital data corresponding to the N asynchronous digital video signals to be written into the frame buffer and which generates read addresses permitting the data stored in the frame buffer to be output to the converter,
where N is an integer equal to or greater that 2.

16. The KVM switch as recited in claim 15, wherein the second switch is controlled by the controller.
